(19) United States
(12) Patent Application Publication
(10) Pub. No.: US 2011/0051432 A1
(43) Pub. Date: Mar. 3, 2011

(54) LED Lamp

(75) Inventors: Oliver Heine, Herrsching (DE); Dirk Schade, Penzberg (DE); Bela Michael Rohrbacher, Heidenheim a. d. Brenz (DE)

(73) Assignee: HEINE OPTOTECHNIK GMBH & CO KG, Herrsching (DE)

(21) Appl. No.: 12/860,962

(22) Filed: Aug. 23, 2010

(30) Foreign Application Priority Data
Aug. 25, 2009 (DE) 10 2009 038 827.3

(51) Int. Cl. F21V 29/00

(52) U.S. Cl. 362/373

(57) ABSTRACT

An LED lamp having a hollow cylindrical housing made of metal and a generally cylindrical elongate cooling body made of ceramic, which is arranged in the housing and the outer surface of which lies against the inner surface of the housing. An LED unit is mounted at the front face of the cooling body. A lens system is mounted at the front-face end of the housing in front of the LED unit. A groove is formed at the outside of the cooling body, which groove extends in the longitudinal direction of the cooling body and in which at least one of the connecting lines for the LED unit is arranged.

### BACKGROUND OF THE INVENTION

The invention relates to an LED lamp comprising an elongated housing in which a LED-unit is accommodated.

DE 202 19 987 U1 discloses an LED lamp having an LED unit accommodated together with an electronic adaptation circuit in a housing, wherein the housing corresponds to the housing of a conventional light bulb. A collective lens is integrated in the transparent part of the housing.

In recent years high-power LEDs have come on the market having an electrical power of up to some Watts. If such a high-power LED is accommodated in a housing, as it is known from DE 202 19 987 U1, there is a strong heat development in the housing, which can result in damage to the high-power LED.

### SUMMARY OF THE INVENTION

The object of the invention is to create an LED lamp by means of a simple design guaranteeing sufficiently high dissipation of heat in order to avoid damage to the LED unit.

This object is achieved by an LED lamp which comprises a hollow, preferably cylindrical housing made of metal, preferably brass, in which an elongated cooling body made of ceramic is arranged. The outer surface of the cooling body contacts the inner surface of the housing. An LED unit is mounted at the front end face of the cooling body. At the front end of the housing a lens system is arranged in front of the LED unit. In order to provide an electrical connection between the LED unit and a contact element provided at the rear end of the housing, which contact element can be brought into contact with a power supply, there is a groove formed in the outside of the cooling body, which groove extends in the longitudinal direction of the cooling body, at least one of the connecting lines for the LED unit being arranged in the groove.

As the ceramic material for the cooling body, for example, CeramCool® can be used, which is sold by the company of CeramTec AG.

By means of the ceramic material the heat can reliably be dissipated from the LED unit. Since the cooling body with its outer surface lies against and contacts the inner surface of the housing made of metal along the whole length of the cooling body , the heat is very well dissipated to the outside, thereby avoiding overheating of the LED unit. In order to guarantee optimal heat transfer between the outer surface of the cooling body and the inner surface of the housing, a heat-conducting paste or a heat-conducting adhesive can be used.

Preferably, connections for the LED unit which are in contact with the connecting lines are metallized onto the front end face of the cooling body made of ceramic, for example, by galvanizing. The cooling body made of ceramic can be directly coated and thus be used as a circuit carrier. At the same time the cooling body is reliably electrically insulated.

In a preferred embodiment the LED unit is connected to the cooling body through a contact surface metallized onto the front face of the cooling body. A high-power LED often has, in addition to the electrical connections, also a metallic surface through which heat can be dissipated. This metallic surface is connected to the metallized contact surface on the cooling body, thereby guaranteeing a reliable dissipation of heat.

Additionally, an electronic circuitry, for example, for regulating the current for the LED unit, can be accommodated in a recess in the cooling body, wherein the recess is preferably formed in the side wall of the cooling body. Circuit paths for the electronic circuitry can also be applied by means of metallization.

It is also possible to form the recess in the rear end face of the cooling body.

In the case of the embodiments according to the invention where an electronic circuitry is arranged in a recess, a storage choke consisting, for example, of a ferrite core surrounded by a choking coil can be arranged adjacent to the rear face of the cooling body in the housing.

The rear face of the housing is preferably closed by an insulating bush in which at least one contact pin is arranged which is connected to at least one connecting line.

Depending on the field of application of the LED lamp, the lens system can be formed by a condenser lens, a rod lens or other lenses or, in the simplest case, by a protecting glass. Between the LED unit and the lens system a great variety of aperture elements can be accommodated.

### BRIEF DESCRIPTION OF THE DRAWINGS

Exemplary embodiments of the invention are hereinafter explained in more detail by way of drawings, in which

FIG. 1 is a perspective view of a first embodiment of an LED lamp according to the present invention;

FIG. 2 shows a longitudinal section of the LED lamp of FIG. 1;

FIG. 3 shows a longitudinal section of a second embodiment of the LED lamp according to the present invention;

FIG. 4 shows the detail X of FIG. 3;

FIG. 5 shows a side view of the cooling body of the LED lamp of FIG. 3;

FIG. 6 shows a front view of the cooling body of FIG. 5.

### DETAILED DESCRIPTION

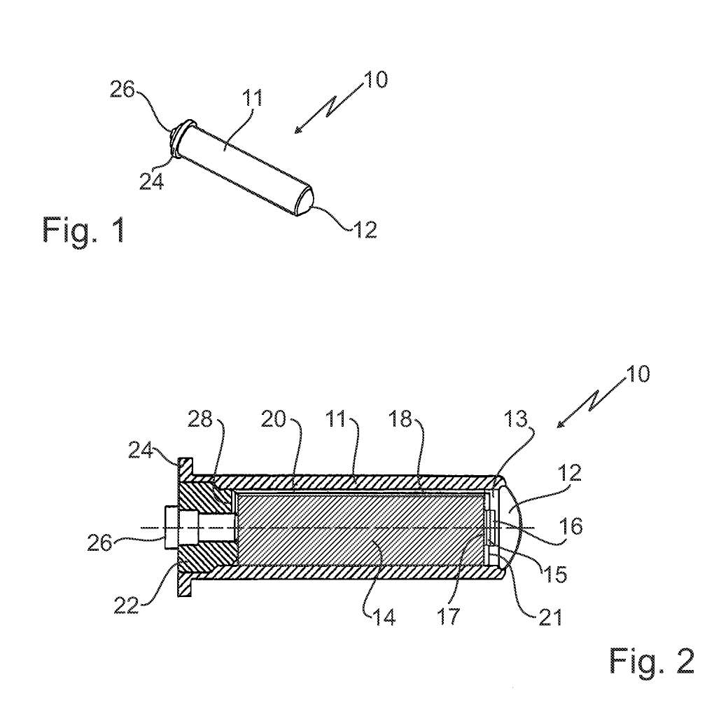

The LED lamp 10 shown in FIGS. 1 and 2 has a generally cylindrical, elongated hollow housing 11 made of metal, for example, brass. The opening at the front end of the housing 11 is closed by a collective lens 12 mounted concentrically to the central axis of the housing 11. At the rear end the housing 11 has a ring collar 24 extending outwardly. The opening at the rear end of the housing 11 is closed by an insulating bush 22 made of insulating material. The rear end of the insulating bush 22 is flush with the rear end of the housing 11. The front end face of the insulating bush 22 extends in a radial plane to the central axis of the housing 11. An elongated, generally cylindrical ceramic body 14 abuts with its rear end face against the front end face of the insulating bush 22. The outer diameter of the ceramic body 14 corresponds to the inner diameter of the housing 11 in this area so that the outer surface of the ceramic body 14 contacts the inner surface of the housing 11 along the whole length of the ceramic body 14. The front face of the ceramic body 14 is spaced apart from the condenser lens 12 so that a clearance 13 is formed between them. An LED unit 16 is mounted centrally at the front end face of the ceramic body 14, wherein the front end face of the LED unit 16 is at a short distance to the condenser lens 12. A first connecting line 21 of the LED unit 16 is connected to the housing 11 through the clearance 13 between the condenser lens 12 and the cooling body 14. Diametrically opposite this connection there is an outer groove 18 formed in the outer surface of the cooling body 14, which outer groove 18 extends in the longitudinal direction of the cooling body 14 and over the whole length of the cooling body 14 and thus forms a passage between the clearance 13 and the rear end of the cooling body 14.

A contact pin 26 is inserted coaxially in the insulating bush 22, wherein the contact pin 26 with its front end lies against the rear end face of the cooling body 14 and the rear end of the contact pin 26 protrudes over the insulating bush 22. A radial groove 28 is formed in the front face of the insulating bush 22, wherein the radial groove 28 is in contact with the outer groove 18 in the cooling body 14 and leads to the contact element 26. A second connecting line 20 of the LED unit 16 is with its one end in contact with the LED unit 16 and with its other end with the contact element 26 and extends via the clearance 13 through the outer groove 18 and the radial groove 28.

In the LED lamp 10 shown in FIGS. 1 and 2 no electronic circuitry for the LED unit 16 is accommodated. The electronic circuitry (not shown) is arranged outside and is in contact with the LED unit 16 through the contact pin 26 and the housing 11.

The LED unit 16 has at its rear side a metallic surface 15 which is connected to a contact surface 17 galvanized onto the front face of the cooling body 14, for example, by soldering, whereby an excellent heat transfer is guaranteed between the LED unit 16 and the cooling body 14.

It is also possible to connect the connecting lines 21 and 20 to contact surfaces metallized onto the front face of the cooling body 14, wherein the contact surfaces in turn are in contact with connections of the LED unit 16.

It is also possible to apply a high-power LED chip directly onto the ceramic body and to bond the connections of the chip directly to the metallized connecting surfaces of the ceramic body.

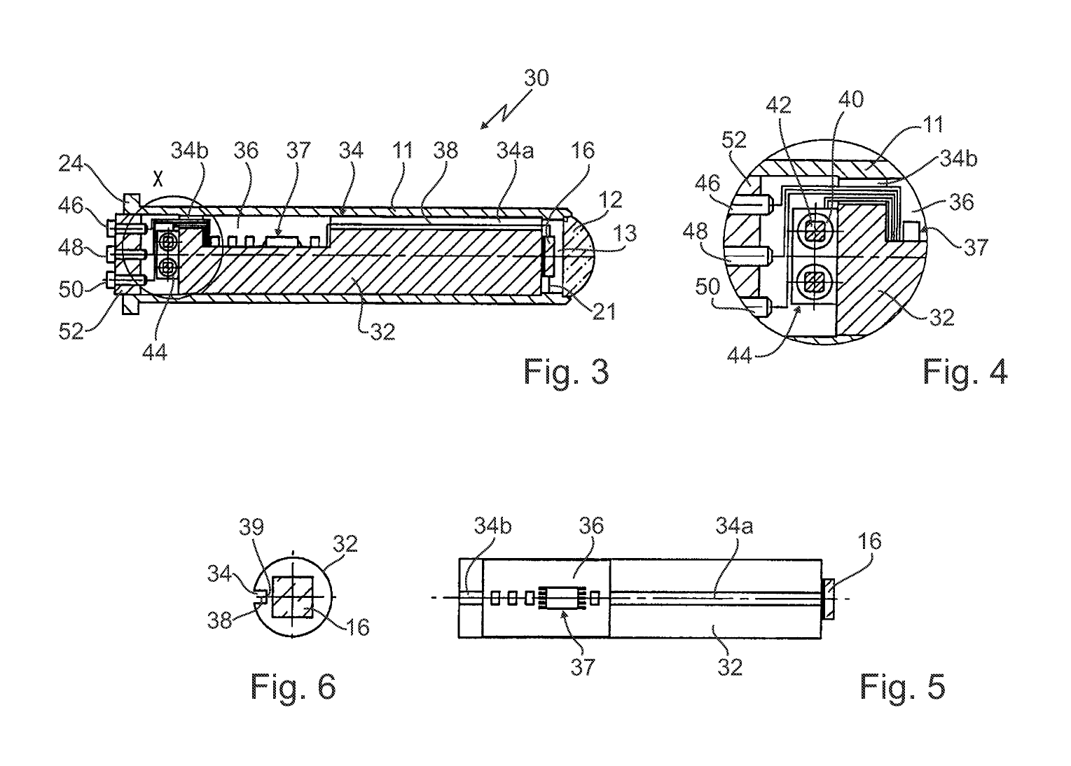

The LED lamp shown in FIG. 3 differs from the LED lamp 10 of FIGS. 1 and 2 essentially in that an electronic circuitry 37 is integrated in the LED lamp 30. Elements which correspond to the ones in the embodiment of FIG. 1 are referred to by the same reference numerals. An outer groove 34 extends in the longitudinal direction of the cooling body 32 and over the whole length of the cooling body 32 and thus forms a passage between the clearance 13 and the rear end of the cooling body 32. The electronic circuitry 37 is arranged in a recess 36 in the cooling body 32, which recess 36 is formed by an enlarged portion of an outer groove 34 formed in the outer surface of the cooling body 32 between a front portion 34a and a rear portion 34b of the outer groove 34. The circuitry paths for the electronic circuitry 37 are galvanized in the recess 36 onto the material of the cooling body 32. Here, too, the first connecting line 21 of the LED unit 16 can be in contact with the housing 11. The second connecting line 38 is in contact with a connecting line 39 metallized by galvanization onto the front end face of the cooling body which in turn is connected to the LED unit 16. The second connecting line 38 extends via the front portion 34a of the outer groove 34 into the recess 36.

The rear end of the housing 11 is closed by an insulating bush 52. A storage choke 44 formed by a ferrite core 42 surrounded by a choking coil 40 is arranged between the front face of the insulating bush 52 and the rear face of the cooling body 32.

The choking coil 40 is in contact with the electronic circuitry 37 via two connecting lines guided through the rear portion 34b of the outer groove 34.

Three contact pins 46, 48, 50 are inserted in the rear face of the insulating bush 52, which contact pins 46, 48, 50 are in contact with the electronic circuitry via connecting wires. Herein one connection can be used for supplying current, another one, for example, for fast switching on and off the LED with chronological synchronism, and another one, for example, for adjusting brightness. The number of the connections can vary depending on the control signals required. A serial bus connection for the various settings and control functions can also be realized. The connections can be designed as contact pins, as shown, but also as a multipolar miniature connector.

1. An LED lamp comprising
(a) a hollow housing made of metal;
(b) an elongated cooling body made of ceramic, which is arranged in said housing and has an outer surface contacting an inner surface of said housing ;
(c) an LED unit mounted at a front face of said cooling body; and
(d) a lens system mounted at a front end of said housing in front of said LED unit,
wherein an outer groove is formed at said outer surface of said cooling body, such that it extends in the longitudinal direction of said the cooling body, at least one connecting line for said LED unit being arranged in said outer groove.

2. The LED lamp according to claim 1, wherein at least one connection for said LED unit which is in contact with said at least one connecting line is metallized onto said front face of said cooling body.

3. The LED lamp according to claim 1, wherein said LED unit is connected to said cooling body through a contact surface metallized onto said front face of said cooling body.

4. The LED lamp according to claim 1, wherein an electronic circuitry for said LED unit is accommodated in a recess in said cooling body.

5. The LED lamp according to claim 4, wherein said recess is formed in the side wall of said cooling body.

6. The LED lamp according to claim 1, wherein a storage choke is arranged as a component of said electronic circuitry in said housing adjacent to the rear face of said cooling body.

7. The LED lamp according to claim 6, wherein said storage choke comprises a ferrite core surrounded by a choking coil.

8. The LED lamp according to claim 1, wherein the rear end of said housing is closed by an insulating bush, in which at least one contact pin is arranged, which is connected to said at least one connecting line.
